(19) United States
(12) Patent Application Publication
(10) Pub. No.: US 2018/0316782 A1
(43) Pub. Date: Nov. 1, 2018

(54) MOBILE TERMINAL

(71) Applicant: LG ELECTRONICS INC., Seoul (KR)

(72) Inventors: Jaehyun CHOI, Seoul (KR); Hyengcheul CHOI, Seoul (KR); Byungwoon JUNG, Seoul (KR); Chisang YOU, Seoul (KR)

(73) Assignee: LG ELECTRONICS INC., Seoul (KR)

(21) Appl. No.: 15/772,028

(22) PCT Filed: Dec. 2, 2015
(86) PCT No.: PCT/KR2015/013020

§ 371 Date: Apr. 27, 2018

(30) Foreign Application Priority Data
Oct. 29, 2015 (KR) 10-2015-0151396

(51) Int. Cl. H04M 1/02

(52) U.S. Cl. CPC H04M 1/026

(57) ABSTRACT

A mobile terminal includes: a display panel; a cover positioned at a rear side of the display panel, the cover having a window region and a conductive region surrounding the window region; a short-range communication antenna positioned between the display panel and the cover, at least a portion of the short-range communication antenna overlapping the window region and insulated from the conductive region; a connecting element positioned at one side of the cover, the connecting element having electromagnetic characteristics; a slit formed on the cover, the slit extending from the window region to an edge of the cover across the conductive region; and a cover circuit inductively coupled to the short-range communication antenna and which is formed on the cover along the connecting element and the conductive region.

### CROSS-REFERENCE TO RELATED APPLICATIONS

This application is the National Stage filing under 35 U.S.C. 371 of International Application No. PCT/KR2015/013020, filed on Dec. 2, 2015, which claims the benefit of earlier filing date and right of priority to Korean Application No. 10-2015-0151396, filed on Oct. 29, 2015, the contents of which are all incorporated by reference herein in their entirety.

### TECHNICAL FIELD

The present invention relates to a mobile terminal. More particularly, the present invention relates to a mobile terminal capable of performing short-range communication, e.g., near field communication (NFC), although it has a metallic casing.

### BACKGROUND ART

Terminals may be classified as mobile/portable terminals and stationary terminals depending on whether the terminals are movable. Mobile terminals may also be classified as handheld terminals and vehicle-mounted terminals depending on whether users may carry the mobile terminal directly.

Functions of mobile terminals have been diversified. For example, there are functions of performing data and voice communication, capturing an image and video through a camera, voice recording, playing music files through a speaker system, and outputting an image or video to a display. Some terminals additionally have an electronic game play function or perform a multimedia player function. In particular, recent mobile terminals may receive multicast signals that provide visual content such as broadcast and video or television programs.

As functions of terminals have been diversified, the terminals have been realized as multimedia players supporting complex functions such as capturing an image or video, playing music or video files, playing games, receiving broadcast, and the like.

In order to support and increase the functionality of such terminals, improvement of the structural and/or software parts of terminals may be considered.

### DISCLOSURE

### Technical Problem

The present invention aims at solving the above-mentioned problems and other problems. Another object of the present invention is to provide a mobile terminal capable of performing short-range communication, although it has a metallic casing.

### Technical Solution

According to an aspect of the present invention, there is provided a mobile terminal including: a display panel; a cover positioned on a rear surface of the display panel and having a window region and a conductive region surrounding the window region; a short-range communication antenna positioned between the display panel and the cover, overlapping the window region in at least a portion thereof, and insulated from the conductive region; a connecting element positioned on one side of the cover and having electromagnetic characteristics; and a slit extending from the window region to an edge of the cover across the conductive region on the cover, wherein a cover circuit inductively coupled to the short-range communication antenna along the connecting element and the conductive region is formed on the cover.

Also, according to another aspect of the present invention, at least a portion of the cover including the conductive region may be formed of a metal material.

Also, according to another aspect of the present invention, a window adjacent portion abut on the window region and a first slit adjacent portion and a second slit adjacent portion each abut on the slit may be formed on the cover, and the connecting element may connect at least two regions among the first slit adjacent portion and the second slit adjacent portion and the window adjacent portion.

Also, according to another aspect of the present invention, the connecting element may have an electromagnetic characteristic value at which the short-range communication antenna and the cover circuit resonate.

Also, according to another aspect of the present invention, the window region may be adjacent to an edge of the cover and elongated along the edge of the cover.

Also, according to another aspect of the present invention, the slit may extend from the window region to an edge adjacent to the window or an edge that the window region faces in a longitudinal direction.

Also, according to another aspect of the present invention, a region in which at least a portion of the short-range communication antenna is bent may be positioned inside a region overlapping the window region.

Also, according to another aspect of the present invention, the short-range communication antenna may have a quadrangular shape in at least a portion overlapping the window region.

Also, according to another aspect of the present invention, at least one side of the short-range communication antenna may overlap the window region, and the at least one slit may be formed abut on a region between a start point and an end point of the at least one side.

Also, according to another aspect of the present invention, the first side of the short-range communication antenna may overlap the window region, a first slit among the plurality of slits may be formed abut on a region between a start point and an end point of the first side, and a second slit among the plurality of slits may be formed abut on a second side extending from the first side.

Also, according to another aspect of the present invention, at least one region of the second side may overlap the window region, and at least another region of the second side may overlap the conductive region.

Also, according to another aspect of the present invention, at least one side of the short-range communication antenna may overlap the window region, and the slit may be formed abut on a region excluding a region between a start point and an end point of the at least one side.

According to another aspect of the present invention, there is provided a mobile terminal including: a display panel; a cover positioned on a rear surface of the display panel and having a window and a conductive region surrounding the window; a short-range communication antenna positioned between the display panel and the cover, overlapping the window region in at least a portion thereof, and insulated from the conductive region; a connecting element positioned on one side of the cover and having electromagnetic characteristics; and a slit extending from the window to an edge of the cover across the conductive region on the cover, wherein at least a portion of a second region including the window in a direction of the cover from the display panel may include the short-range communication antenna.

Also, according to another aspect of the present invention, a third region including the slit may be positioned outside the first region.

Also, according to another aspect of the present invention, a window adjacent portion abut on the window and a first slit adjacent portion and a second slit adjacent portion each abut on the slit may be formed on the cover, and the connecting element may connect at least two regions among the first slit adjacent portion and the second slit adjacent portion and the window adjacent portion.

Also, according to another aspect of the present invention, a cover circuit inductively coupled to the short-range communication antenna along the connecting element and the conductive region may be formed on the cover, and the connecting element may have an electromagnetic characteristic value at which the short-range communication antenna and the cover circuit resonate.

According to another aspect of the present invention, there is provided a mobile terminal including: a display panel; a cover positioned on a rear surface of the display panel and formed of a metal material in a least a portion of the cover; a short-range communication antenna positioned between the display panel and the cover; and a resonating unit disposed on one side of the cover to form a closed loop together with a region of the cover formed of a metal material and providing electromagnetic characteristics such that the closed loop is inductively coupled with the short-range communication antenna and resonates.

Also, according to another aspect of the present invention, the cover may have a window surrounded by the metal material of the cover and include a slit extending from the window to an edge of the cover across the conductive region on the cover, a window adjacent portion abut on the window and a first slit adjacent portion and a second slit adjacent portion each abut on the slit may be formed on the cover, and the connecting element may connect at least two regions among the first slit adjacent portion and the second slit adjacent portion and the window adjacent portion.

Also, according to another aspect of the present invention, there is provided a mobile terminal including: a display panel; a cover positioned on a rear surface of the display panel and having a conductive region and a window region formed abut on the conductive region and extending to an edge; a short-range communication antenna positioned between the display panel and the cover, overlapping the window region in at least a portion thereof, and insulated from the conductive region; a printed circuit board (PCB) positioned between the display panel and the cover and having a contact member abut on the conductive region and a current path allowing a current to flow therethrough; and a rib connected to opposing ends of the current path and allowing a current to flow therein, wherein a cover circuit inductively coupled with the short-range communication antenna along the conductive region, the current path, and the rib is formed.

Also, according to another aspect of the present invention, the cover circuit and the window region may overlap in at least a portion in a direction toward the cover from the display panel.

### Advantageous Effects

The effects of the mobile terminal according to the present invention will now be described.

According to at least one of the embodiments of the present invention, short-distance communication may be performed, while having a metallic casing.

Further scope of applicability of the present invention will become apparent from the following detailed description. It should be understood, however, that the detailed description and specific examples, such as the preferred embodiments of the invention, are given by way of illustration only, since various changes and modifications within the spirit and scope of the invention will be apparent to those skilled in the art.

### DESCRIPTION OF DRAWINGS

FIGS. 1A and 1B are conceptual diagrams illustrating an example of a mobile terminal according to the present invention, viewed in different directions.

FIG. 2 is a conceptual view for explaining another example of a mobile terminal according to the present invention.

FIG. 3 illustrates an example of a configuration and operation of a short-range communication antenna according to the present invention.

FIGS. 4 to 8 illustrate examples of a mobile terminal according to an embodiment of the present invention.

FIGS. 9 to 12 illustrate an example of a cross-section of the mobile terminal according to FIG. 8.

FIGS. 13 to 17 illustrate examples of a cover of a mobile terminal according to an embodiment of the present invention.

FIGS. 18 to 24 illustrate examples of an arrangement of a slit and a connecting element according to an embodiment of the present invention.

FIG. 25 illustrates an operation of a cover circuit according to an embodiment of the present invention.

FIG. 26 illustrates an equivalent circuit regarding a short-range communication antenna and a cover circuit according to an embodiment of the present invention.

FIG. 27 illustrates driving of a short-range communication antenna and a cover circuit according to an embodiment of the present invention.

FIG. 28 illustrates an experimental example of a mobile terminal according to an embodiment of the present invention.

FIG. 29 illustrates an example of a radiation effect of a short-range communication antenna according to an embodiment of the present invention.

FIG. 30 is a view illustrating a mobile terminal according to another embodiment of the present invention.

FIG. 31 is a view illustrating a cover of the mobile terminal of FIG. 30.

FIG. 32 is an exploded side cross-sectional view of the mobile terminal of FIG. 30.

FIG. 33 is a view illustrating a cover circuit formed in the mobile terminal of FIG. 30.

FIG. 34 is a block diagram illustrating a mobile terminal according to the present invention.

FIG. 35 illustrates an example of a local region communication method of a mobile terminal according to an embodiment of the present invention.

FIG. 36 illustrates an example of the use of a mobile terminal according to an embodiment of the present invention.

### BEST MODES

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above.

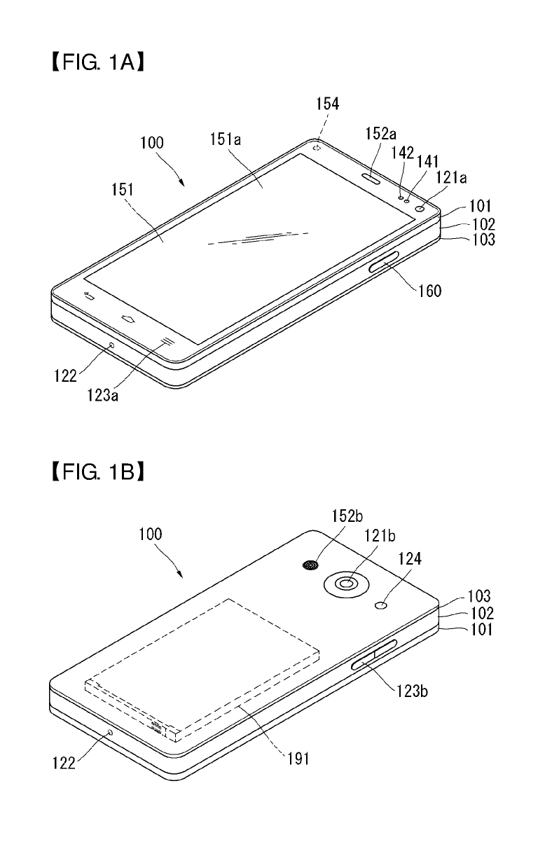

Referring to FIGS. 1A and 1B, FIGS. 1A and 1B are conceptual views illustrating an example of a mobile terminal viewed in different directions.

Referring to FIGS. 1A and 1B, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood as a concept of designating the mobile terminal 100 by considering the mobile terminal 100 as at least one assembly.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output unit 152b.

The cases 101, 102, 103 may be formed by injection-molding synthetic resin or may be formed of a metal material, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the first audio output unit 152a, the second audio output unit 152b, the proximity sensor 141, the illumination sensor 142, the optical output module 154, the first camera 121a, the second camera 121b, the first manipulation unit 123a, the second manipulation unit 123b, the microphone 122, the interface unit 160, etc.

Hereinafter, the mobile terminal 100 will be explained with reference to FIGS. 1A and 1B. The display unit 151, the first audio output unit 152a, the proximity sensor 141, the illumination sensor 142, the optical output module 154, the first camera 121a and the first manipulation unit 123a are arranged on the front surface of the terminal body. The second manipulation unit 123b, the microphone 122 and the interface unit 160 are arranged on the side surfaces of the terminal body. The second audio output unit 152b and the second camera 121b are arranged on the rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output unit 152b may be located on the side surface of the terminal body.

The display unit 151 outputs information processed in the mobile terminal 100. For example, the display unit 151 may display information on an execution screen of an application program driven in the mobile terminal 100, or a user interface (UI) or a graphic user interface (GUI) associated with such execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the control unit 180, for example, may generate a control command or other signal corresponding to the touch. The content which is input in the touching manner may be text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output unit 152a may be implemented as a receiver for transmitting a call sound to a user's ears, and the second audio output unit 152b may be implemented as a loud speaker for outputting each type of alarm sounds or a play sound of multimedia.

It may be configured such that the sounds generated from the first audio output unit 152a are released along an assembly gap between the structural bodies (e.g., between the window 151a and the front case 101). In this case, a hole independently formed to output audio sounds may not be seen or hidden in terms of appearance, thereby further simplifying the appearance of the mobile terminal 100.

The optical output module 154 can output a signal for indicating an event generation using light of a light source. Examples of events generated in the mobile terminal 100 may include message reception, call signal reception, a missed call, an alarm, a schedule notice, an email reception, information reception through an application, and the like. A signal output by the optical output module 154 may be implemented in such a manner that the mobile terminal emits monochromatic light or light with a plurality of colors. The signal output may be terminated as the mobile terminal senses that a user has checked the generated event, for example.

The first camera 121a processes image data of still pictures or video acquired by an image capture device in a video capturing mode or an image capturing mode. The processed image frames may be displayed on the display unit 151 or may be stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion and may employ any tactile method that allows the user to perform manipulation such as touch, push, scroll, or the like. The first and second manipulation units 123a and 123b may be implemented in a user's non-tactile manner, e.g., by a proximity touch, a hovering touch, etc.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output units 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output units 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The control unit 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown adjacent to the second camera 121b. When an image of a subject is captured with the camera 121b, the flash 124 may illuminate the subject.

The second audio output unit 152b can be located on the terminal body. The second audio output unit 152b may implement stereophonic sound functions in conjunction with the first audio output unit 152a and may be also used for implementing a speaker phone mode for call communication.

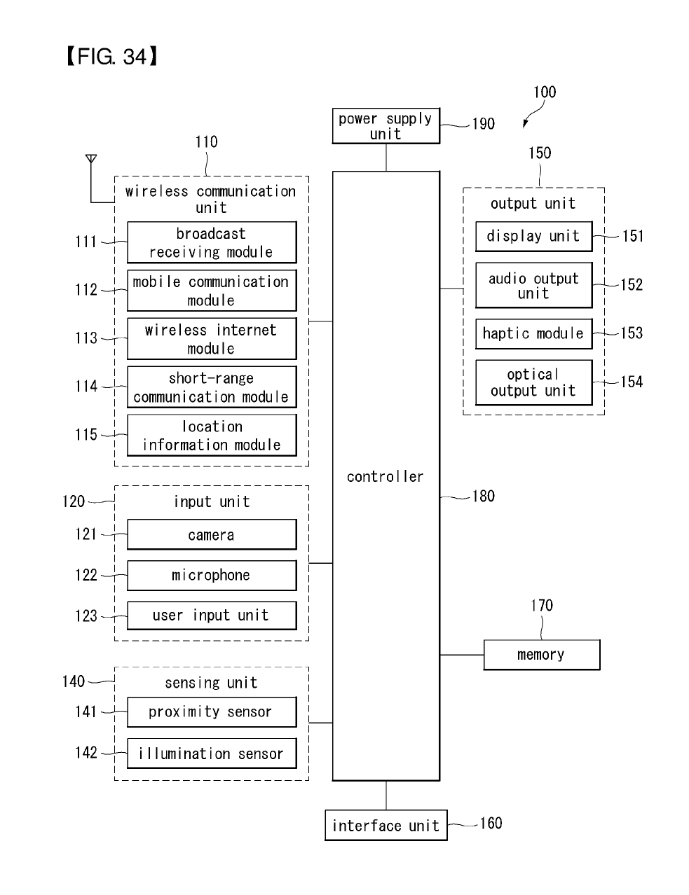

At least one antenna for wireless communication may be located on the terminal body. The antenna may be installed in the terminal body or formed by the case. For example, an antenna which configures a part of the broadcast receiving module 111 (refer to FIG. 34) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 102 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, in the present invention, information processed in the mobile terminal may be displayed using a flexible display. This will be described in detail with reference to the accompanying drawings hereinafter.

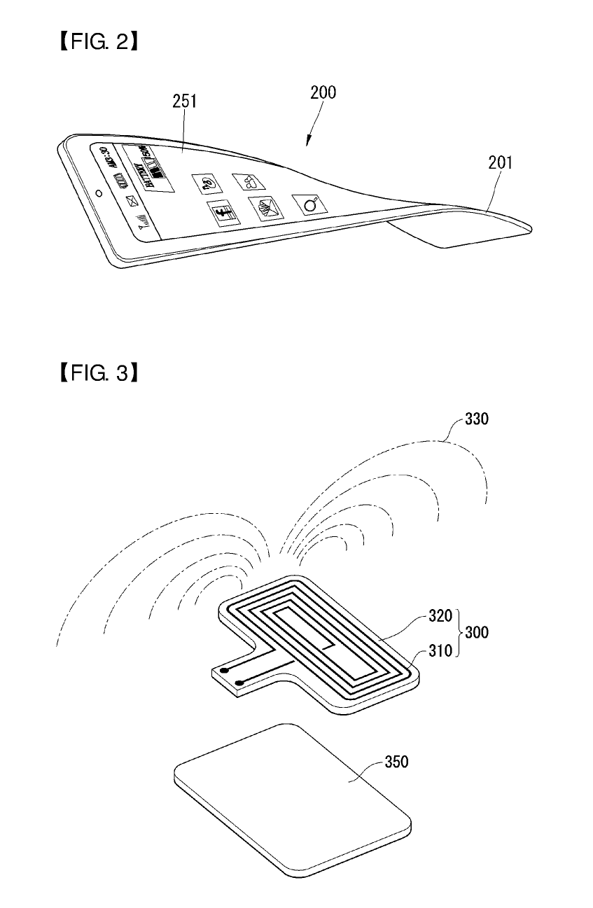

FIG. 2 is a conceptual view illustrating another example of a deformable mobile terminal 200 according to the present invention.

As illustrated, display unit 251 may be configured to be deformable by an external force. The deformation may be at least one of bowing, bending, folding, twisting, and rolling. The deformable display unit 251 may be referred to as a “flexible display unit”. Here, the flexible display unit may include a general flexible display, e-paper, and a combination thereof. In general, the mobile terminal 200 may include the features of the mobile terminal 100 of FIGS. 1A and 1B or features similar thereto.

The general flexible display refers to a solid display manufactured on a thin, pliable substrate which is bowable, bendable, foldable, and twistable, or rollable, so as to be light and not easily brittle, while maintaining characteristics of an existing flat panel display.

Also, the e-paper, based on a display technology employing features of a general ink, may be different from an existing flat panel display in that it uses reflected light. In e-paper, information may be changed using electrophoresis using a twist ball or a capsule.

In a state in which the flexible display unit 251 is not deformed (for example, a state in which the display unit 151 has an infinite radius of curvature, which is referred to as a “first state”, hereinafter), a display region of the flexible display unit 251 is flat. In a state in which the flexible display unit 251 in the first state is deformed by an external force (for example, a state in which the flexible display unit 251 has a finite radius of curvature, which will be referred to as a “second state”, hereinafter), the display region may be curved. As illustrated, information displayed in the second state may be visual information output on the curved surface. The visual information is implemented as light emission of unit pixels (or subpixels) disposed in a matrix form is independently controlled. The subpixel refers to a minimum unit for implementing a single color.

The flexible display unit 251 may be placed in a bent state (for example, a vertically or horizontally bent state), not a flat state, from the first state. In this case, when an external force is applied to the flexible display unit 251, the flexible display unit 251 may be deformed to a flat state (or a less bent state) or more bent state.

Meanwhile, the flexible display unit 251 may be combined with a touch sensor to implement a flexible touch screen. When a touch is applied to the flexible touch screen, the controller 180 (See FIG. 34) may perform controlling corresponding to the touch input. The flexible touch screen may be configured to sense a touch input even in the second state, as well as in the first state.

The mobile terminal 200 according to the present modification may have a deformation sensing unit for sensing deformation of the flexible display unit 251. The deformation sensing unit may be included in the sensing unit 140 (See FIG. 34).

The deformation sensing unit may be provided in the flexible display unit 251 or the case 201 to sense information related to deformation of the display unit 151. Here, the information related to deformation may include a direction in which the flexible display unit 251 is deformed, a degree to which the flexible display unit 251 is deformed, a deformed position of the flexible display unit 251, a deformation time, acceleration at which the deformed flexible display unit 251 is restored, and the like, and may also include various types of information that can be sensed as the display unit 151 is bent.

Also, on the basis of the information related to deformation of the flexible display unit 251 sensed by the deformation sensing unit, the controller 180 may change information displayed on the flexible display unit 251 or generate a control signal for controlling a function of the mobile terminal 200.

Meanwhile, the mobile terminal 200 according to the present modification may include a case 201 accommodating the flexible display unit 251. The case 201 may be configured to be deformable together with the flexible display unit 251 by an external force in consideration of characteristics of the flexible display unit 251. That is, the flexible display unit 251 is formed to be bent together with the case 201.

In addition, a battery (not shown) provided in the mobile terminal 200 may also be configured to be deformable together with the flexible display unit 251 by an external force in consideration of characteristics of a battery (not shown) or the flexible display unit 251 provided in the mobile terminal 200. In order to implement the battery, a stack and folding scheme in which battery cells are piled upwardly may be applied.

Deformation of a state of the flexible display unit is not limited to deformation based on an external force. For example, when the flexible display unit 251 is in the first state, the flexible display unit 251 may be deformed to the second state by the user or according to a command of an application.

FIG. 3 illustrates an example of a configuration and operation of a short-range communication antenna according to the present invention. FIG. 3 illustrates an antenna 300 for short-range communication (or short-range communication antenna 300) and a shielding film 350.

The short-range communication antenna 300 may include a coil 310. That is, the coil 310 may be referred to as the short-range communication antenna 300. Also, the short-range communication antenna 300 may include an antenna board 320, and in this case, the coil 310 may be positioned on a board 320. The short-range communication antenna 300 may be, for example, a near-field communication (NFC) antenna. The antenna board 320 may be a flexible material or a hard material. When the antenna board 320 is formed of a flexible material, the antenna board 320 may be in the form of a film. For example, the short-range communication antenna 300 may be a flexible printed circuit board (FPCB). Here, the coil 310 may form winding on the antenna board 320. The winding may be made one time or more.

The shielding film 350 may be formed of an electromagnetic wave shielding material to minimize an influence of the outside made on an electromagnetic field 330 formed by the short-range communication antenna 300. For example, the shielding film 350 may be a ferrite sheet. Here, the electromagnetic wave has the same meaning as that of an electromagnetic field.

When the electromagnetic field 330 is formed in the short-range communication antenna 300, a current may flow through the coil 310. Conversely, when an electric current flows in the coil 310, the electromagnetic field 330 may be formed in the short-range communication antenna 300. Using this, the mobile terminal may transmit and receive signals to and from an external terminal. Here, the shielding film 350 may be positioned on the opposite side of the external terminal with respect to the short-range communication antenna 300, improving noise suppression and sharpness (quality factor or selectivity).

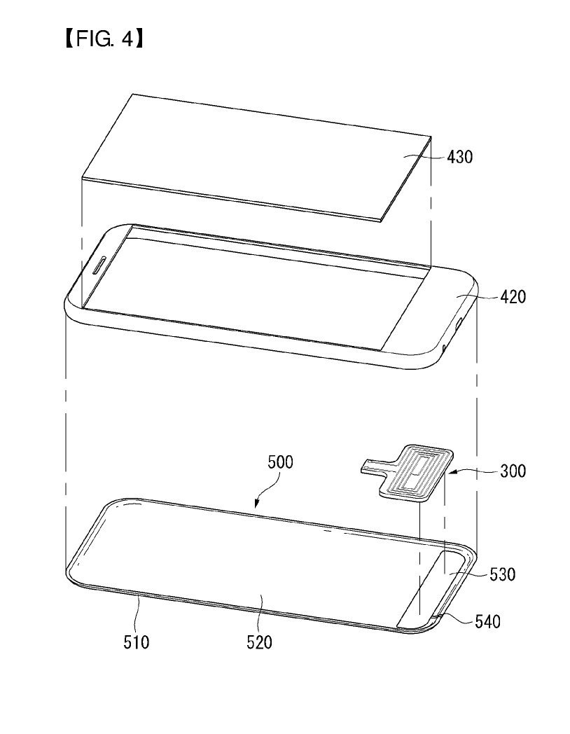

FIG. 4 illustrates an example of a mobile terminal according to an embodiment of the present invention. FIG. 4 illustrates a frame 420, a display panel 430, the short-range communication antenna 300, and a cover 500. The frame 420 may be a frame of the mobile terminal or a frame of the display panel 430. The frame 420 serves for fixing an electronic component to an appropriate position and is not limited thereto as long as it may be interpreted in this sense.

The display panel 430 may be an LCD panel or an OLED panel. The display panel 430 may not be limited thereto.

The cover 500 may include an edge 510 as a rim, a conductive region 520, a window 530, and a slit 540. The conductive region 520 is a region of the cover 500 where a current may be formed, and the window 530 is surrounded by the conductive region 520 and a region in which current is not formed. The window 530 may be referred to as a window region 530. The slit 540 may extend from the window 530 to the edge 510 across the conductive region 520. When the slit 540 and the conductive region 520 are connected, a closed loop may be formed. The conductive region 520 may be formed of a metal material.

The short-range communication antenna 300 is positioned between the frame 420 and the display panel 430. The short-range communication antenna 300 may overlap the window region 530 and may be insulated from the conductive region 520.

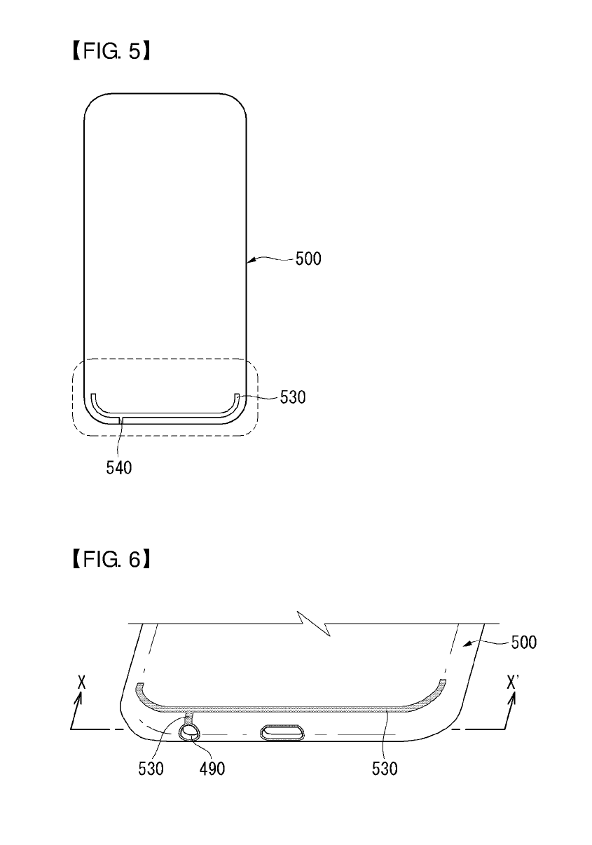

FIGS. 5 to 7 illustrate an example of a mobile terminal according to an embodiment of the present invention. FIG. 5 illustrates the cover 500, the window region 530, and the slit 540. In FIG. 5, it is illustrated that the window region 530 may be positioned at a lower portion of the mobile terminal. The window region 530 may be positioned at an upper portion or at left and right portions, as well as at the lower portion of the mobile terminal, and may be positioned at an edge of the mobile terminal.

FIG. 6 is an enlarged perspective view of the dotted line region of FIG. 5. When an earphone jack 490 is formed at a lower portion of the mobile terminal, the slit 540 may be formed using a structure of the earphone jack 490. In the case of using the structure of the earphone jack 490, the slit 540 may be positioned to correspond to the position of the earphone jack 490, whereby a metal material of the earphone jack 490 and the cover 500 may be insulated.

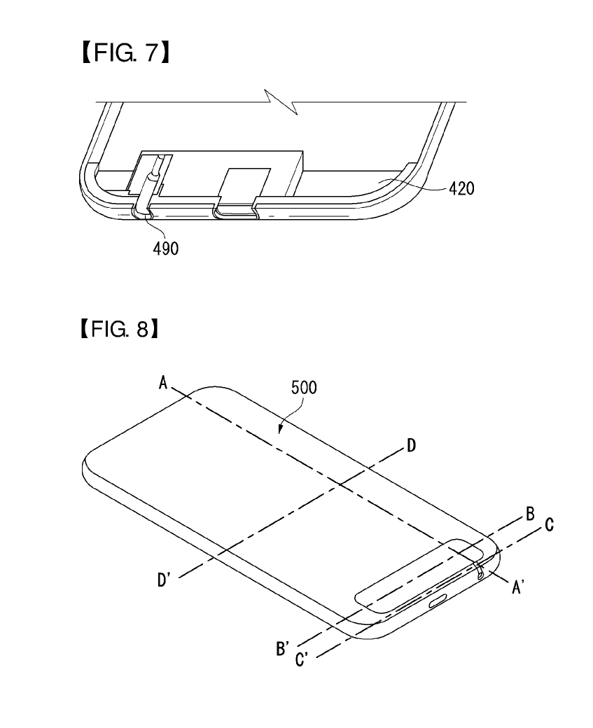

FIG. 7 illustrates a state when the mobile terminal is taken in a direction of X-X′ of FIG. 6. The earphone jack 490 may be formed at the frame 420, and the slit 540 illustrated in FIG. 6 may be located on the cover 500 corresponding to the earphone jack 490.

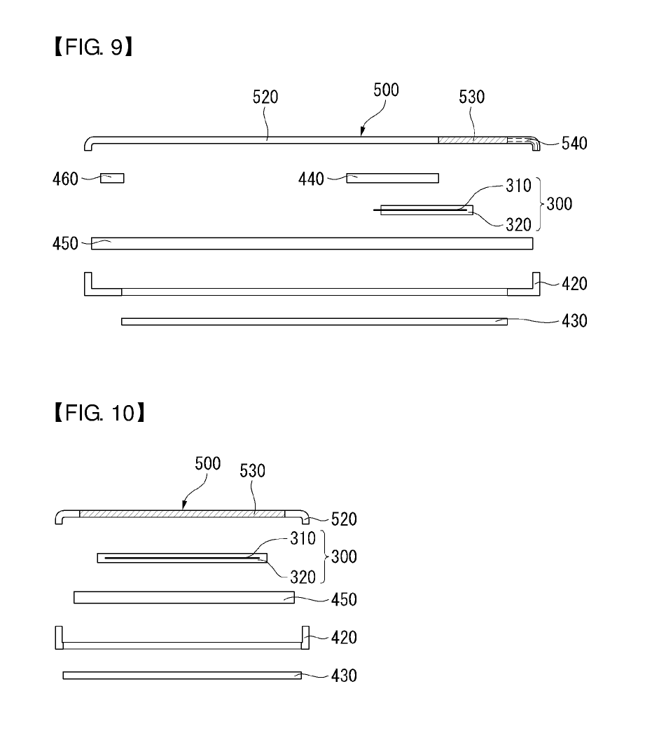

FIG. 8 illustrates an example of a mobile terminal according to an embodiment of the present invention. FIG. 8 is a perspective view of a rear side of the mobile terminal, illustrating lines (A-A′, B-B′, C-C′, and D-D′) indicating cross-sections of the mobile terminal. FIGS. 9 to 12 illustrate an example of a cross-section of the mobile terminal according to FIG. 8.

FIG. 9 is a cross-sectional view of the mobile terminal according to FIG. 8, taken along line A-A′. The line A-A′ traverses the slit 540, as a longitudinal direction of the mobile terminal. FIG. 9 illustrates the display panel 430, the cover 500 positioned on the rear surface of the display panel 430, the short-range communication antenna 300, the frame 420, a printed circuit board (PCB) 450, an impedance sensor 460, and an insulating film 440. The frame 420 may serve to connect the display panel 430 and the cover 500. A controller (not shown) for controlling an operation of the mobile terminal may be mounted on the PCB 450, and the controller may control the short-range communication antenna 300. The impedance sensor 460 may measure impedance of a cover circuit as described later, and impedance of the measured cover circuit may be transmitted to the controller and processed.

The conductive region 520, the window region 530, and the slit 540 may be arranged on cover 500 along line A-A′. As illustrated in FIG. 9, the window region 530 and the short-range communication antenna 300 overlapped each other, and the short-range communication antenna 300 is insulated from the conductive region 520 by the insulating film 440. The short-range communication antenna 300 may include the coil 310 and the antenna board 320. In FIG. 9, it is illustrated that the short-range communication antenna 300 is separated from the PCB 450, but the short-range communication antenna 300 may be mounted on the PCB 450.

FIG. 10 is a cross-sectional view of the mobile terminal according to FIG. 8, taken along line B-B′. The line B-B′ traverses the window region 530, as a transverse direction of the mobile terminal. FIG. 10 illustrates the display panel 430, the cover 500 positioned on the rear surface of the display panel 430, the short-range communication antenna 300, the frame 420, and the PCB 450. The frame 420 may serve to connect the display panel 430 and the cover 500.

The conductive region 520 and the window region 530 may be arranged on cover 500 along line B-B′. As illustrated in FIG. 10, the window region 530 and the short-range communication antenna 300 overlap. The short-range communication antenna 300 may include the coil 310 and the antenna board 320. In FIG. 10, it is illustrated that the short-range communication antenna 300 is separated from the PCB 450, but the short-range communication antenna 300 may be mounted on the PCB 450.

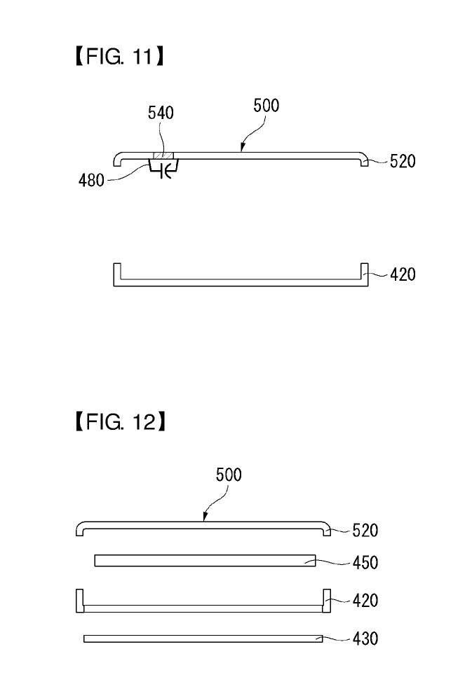

FIG. 11 is a cross-sectional view of the mobile terminal of FIG. 8, taken along line C-C′. The line C-C′ traverses the slit 540, as a transverse direction of the mobile terminal. FIG. 11 illustrates the cover 500, the frame 420, and a connecting element 480.

The conductive region 520 and slit 540 may be arranged on the cover 500 along line C-C′. In FIG. 11, the connecting element 480 may connect both sides of the conductive region 520 abut on the slit 540, whereby the connecting element 480 and the conductive region 520 may form a cover circuit as a closed loop. Although not illustrated in FIG. 11, the short-range communication antenna and the cover circuit may form inductive coupling. When a current flowing through the short-range communication antenna is changed due to inductive coupling between the short-range communication antenna and the cover circuit, a magnetic field penetrating through the inside of the cover circuit is changed to induce a current in the cover circuit. As the current is induced in the cover circuit, the cover circuit may serve as another antenna.

Metal materials have the properties of blocking electromagnetic waves. Therefore, the cover 500 formed of a metal material generally has the non-conductive window region 520 for communication such as LTE, or the like, but the area of the window region 520 may be limited in relation to a design of the mobile terminal. For short-range communication such as NFC, the window region 520 may be used, but if the area of the window region 520 is not secured as a predetermined area, electromagnetic waves formed by the short-range communication antenna may be difficult to propagate to the outside of the mobile terminal by predetermined strength or greater. The cover circuit may be inductively coupled to the short-range communication antenna, thereby performing the function of propagating the electromagnetic waves to the outside of the mobile terminal.

FIG. 12 is a cross-sectional view of the mobile terminal according to FIG. 8, taken along line D-D′. The line D-D′ traverses the conductive region 520, as a transverse direction of the mobile terminal. FIG. 12 illustrates the display panel 430, the cover 500 positioned on the rear surface of the display panel 430, the frame 420, and the PCB 450. The frame 420 may serve to connect the display panel 430 and the cover 500.

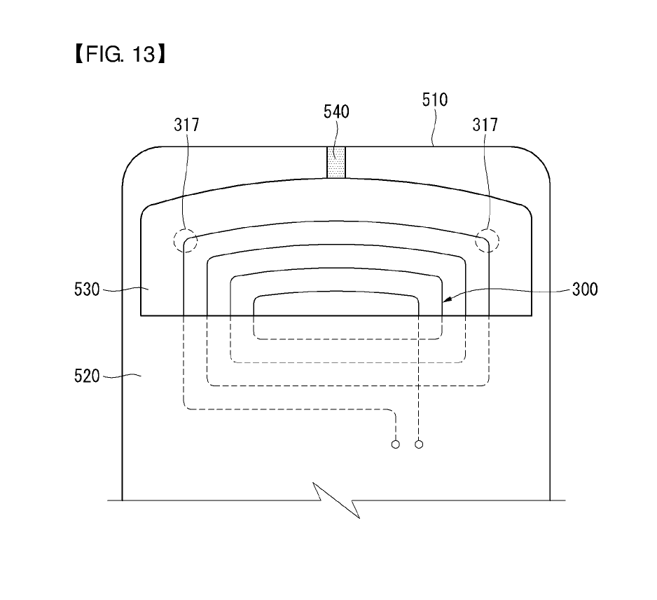

FIGS. 13 to 17 illustrate examples of a cover of a mobile terminal according to an embodiment of the present invention. The window region 530 may be disposed at an upper portion of the cover.

As illustrated in FIG. 13, the window region 530 may be disposed at an upper portion the cover, and at least a portion thereof may be convex toward the edge 510. The window region 530 and the short-range communication antenna 300 may overlap. The region of the short-range communication antenna 300 that overlaps the window region 530 may correspond to a shape of the window region 530. The slit 540 may extend from the window region 530 to the edge 510 and traverse the conductive region 520.

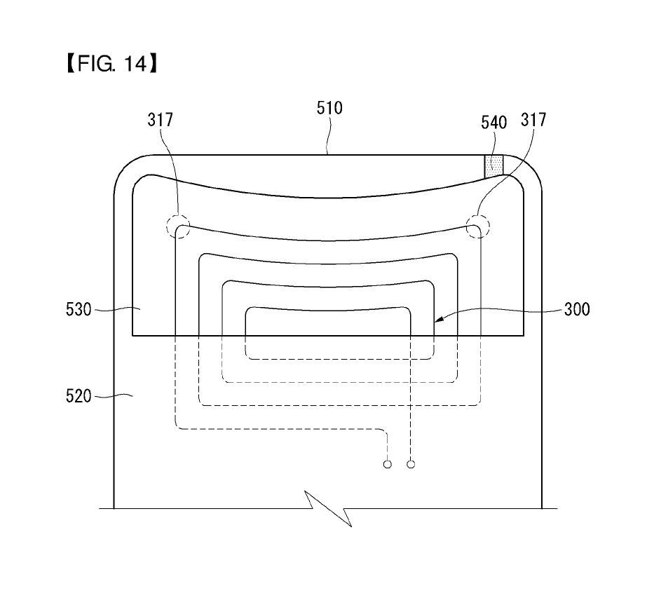

As illustrated in FIG. 14, the window region 530 may be disposed at an upper portion the cover, and at least a portion thereof may be concave toward the edge 510. The window region 530 and the short-range communication antenna 300 may overlap. The region of the short-range communication antenna 300 that overlaps the window region 530 may correspond to the shape of the window region 530. The slit 540 may extend from the window region 530 to the edge 510 and traverse the conductive region 520.

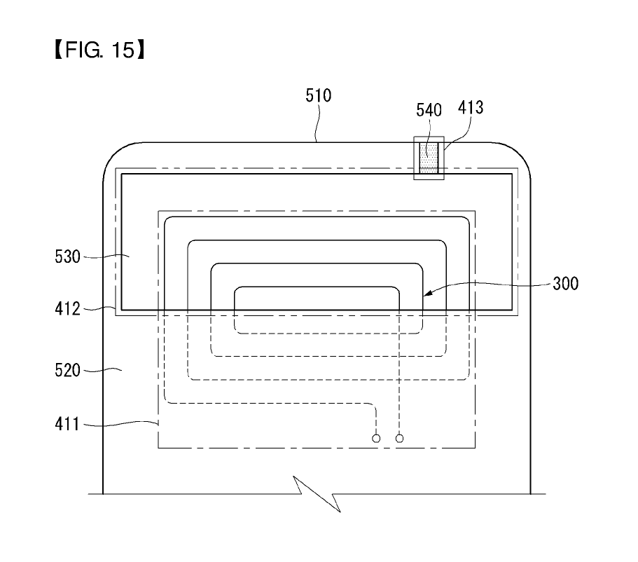

FIG. 15 illustrates the conductive region 520, a first region 411 including the short-range communication antenna 300, a second region 412 including the window 530, and a third region 413 including the slit 540. In FIG. 9, the first region 411 is indicated by the alternated long and short dash line, the second region 412 is indicated by the alternate long and two short dashes line, and the third region 413 is indicated by the solid line.

As illustrated in FIG. 15, at least a portion of the second region 412 may be positioned inside the first region 411, and the third region 413 may be positioned outside the first region 411.

The short-range communication antenna 300 may propagate electromagnetic waves through the second region 412 overlapping the first region 411. When a connecting element is connected to a portion of the conductive region 520 abut on both sides of the slit 540, a current may be induced to the cover circuit connecting the conductive region 520 and the connecting element by electromagnetic waves passing through the second region. Here, since the third region 413 is positioned outside the first region 411, the electromagnetic waves passing through the cover circuit may be maximized.

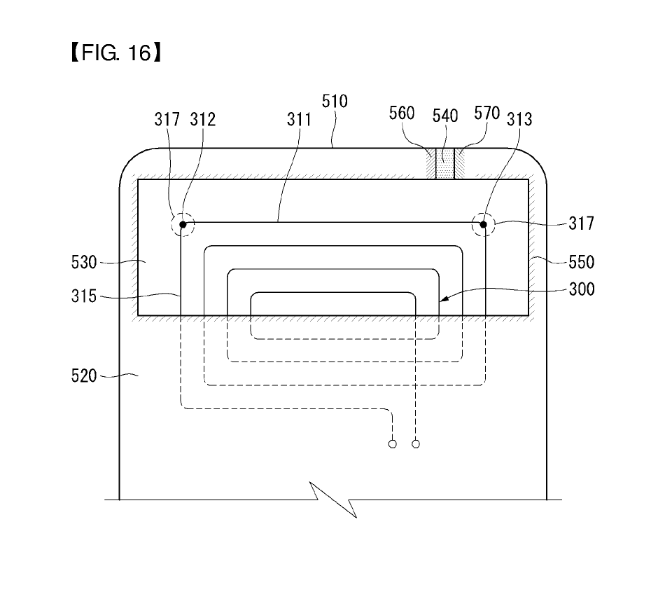

FIG. 16 illustrates the near-field communication antenna 300, the edge 510, a window adjacent portion 550 abut on the window region 530, a first slit adjacent portion 560 and a second slit adjacent portion formed abut on the slit 540.

The window region 530 may be abut on the edge 510 and elongated along the edge 510. The slit 540 may extend from the window region 530 to an edge 510 adjacent to the window region 530 or to the edge 510 that the window region 530 faces in a longitudinal direction of the window region 530. The slit 540 illustrated in FIG. 16 is formed from the window region 530 to the edge 510 adjacent to the window region 530.

Referring to the short-range communication antenna 300, at least a portion of the short-range communication antenna 300 may be bent inside a region in which the short-range communication antenna 300 overlaps the window region 530. As illustrated in FIG. 16, bent regions 317, i.e., bent regions of the short-range communication antenna 300, are positioned inside a region in which the window region 530 and the short-range communication antenna 300 overlap. Also, at least a portion of the region of the short-range communication antenna 300 overlapping the window region 530 may have a quadrangular shape. Here, a first side 311 of the short-range communication antenna 300 may be positioned in the region overlapping the window region 530 and the first side 311 may include a start point 312 and an end point 313. As illustrated in FIG. 16, the slit 540 may be formed adjacent to a region between the start point 312 and the end point 313 on the cover.

Referring to the conductive region 520, the window adjacent portion 550 may be formed abut on the window region 530. Also, the first slit adjacent portion 560 and the second slit adjacent portion 570 may be formed abut on the slit 540. When two of the three regions are connected by the connecting element (FIG. 11), a cover circuit in which a current is formed along the connecting element and the conductive region 520 may be configured. As described above, the cover circuit may be inductively coupled with the short-range communication antenna 300.

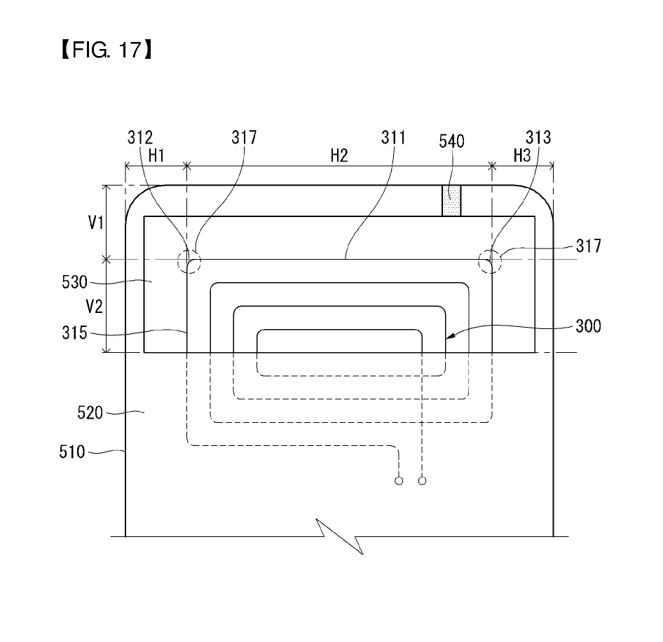

FIG. 17 illustrates the positional relationship between the slit 540 and the short-range communication antenna 300. The first side of the short-range communication antenna 300 overlaps the window region 530. The bent regions 317 of the short-range communication antenna 300 are formed at both ends of the first side 311 and the second side 315 extends from the first side 311.

Since the slit 540 may be formed from the window region 530 to the edge 510 abut on the window region 530 or to the edge 510 that the window 530 faces in the longitudinal direction thereof, and thus, the region in which the slit 540 is formed may be distinguished with respect to a position of the short-range communication antenna 300 overlapping the window region 530.

The bent regions 317 of the short-range communication antenna 300 may be used as a reference for distinguishing the region where the slit 540 is formed, and the start point 312 and the end point 313, which are both ends of the first side 311, may be a reference for distinguishing the region where the slit 540 is formed.

The conductive region 520 adjacent to the region between the start point 312 and the end point 313 may be referred to as ‘H2’ and the remaining portions in the longitudinal direction of H2 may be referred to as ‘H1’ and ‘H3’, respectively. Meanwhile, the conductive region 520 adjacent to the second side starting from the start point 312 may be referred to as ‘V2’, and a region where the conductive region 520 meets H1 or H2 in the longitudinal direction of V2 may be referred to as ‘V1’.

The slit 540 may be formed in H1, H2, and H3, and may be formed in V1 and V2. As illustrated in FIG. 17, for example, the slit 540 may be formed in H2. Since the slit 540 may be formed in plurality, two slits 540 may be formed in H2.

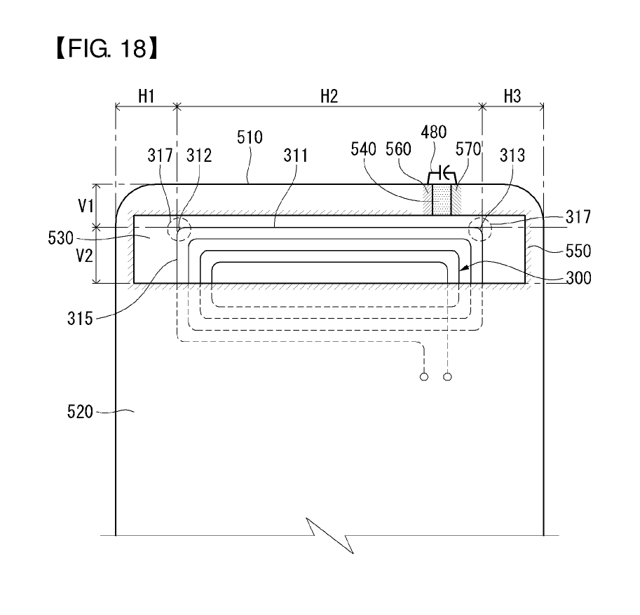

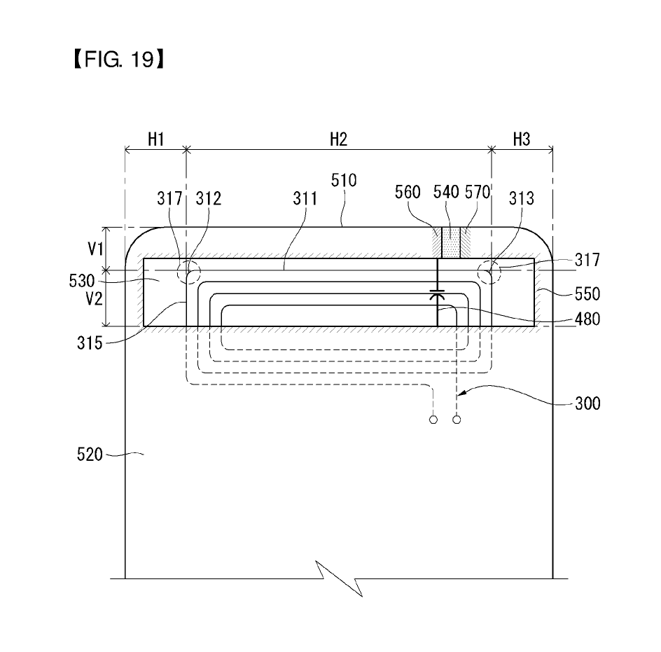

FIGS. 18 and 19 illustrate a position of the slit 540 and a connection relation of the connecting element 480.

In FIGS. 18 and 19, the slit 540 is positioned at H2. That is, the slit 540 may be formed adjacent to a region between the start point 312 and the end point 313 of the first side 311. The connection relation of the connecting element 480 will be described. As illustrated in FIG. 18, the connecting element 480 may connect the first slit adjacent portion 560 and the second slit adjacent portion 570 formed abut on the slit 540. Also, as illustrated in FIG. 19, the connecting element 480 may connect the first slit adjacent portion 560 and the window adjacent portion 550. Although not shown, the connecting element 480 may connect the second slit adjacent portion 570 and the window adjacent portion 550. In this manner, a cover circuit in which a current is formed along the connecting element 480 and the conductive region 520 may be formed through the connection by the connecting element 480.

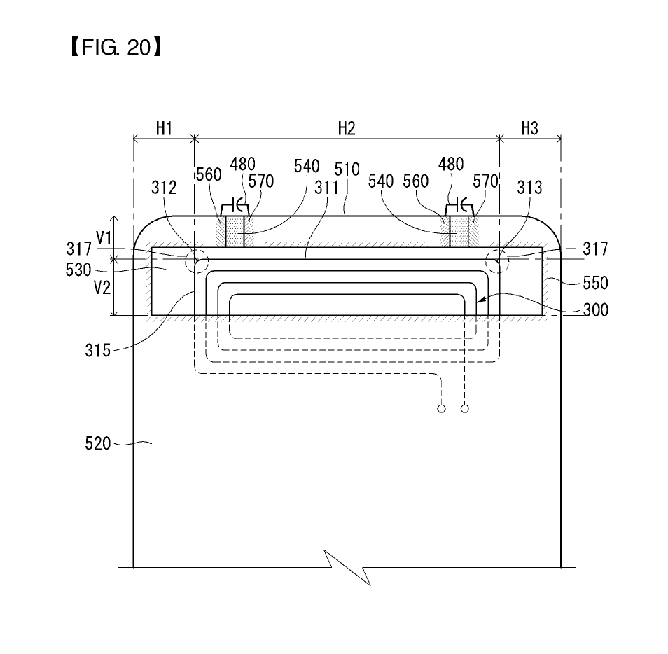

FIGS. 20 to 22 illustrate a position of the slit 540 and a connection relation of the connecting element 480.

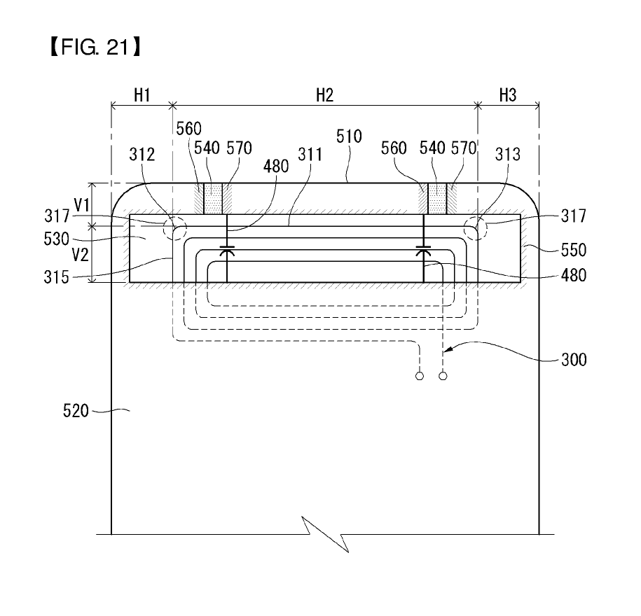

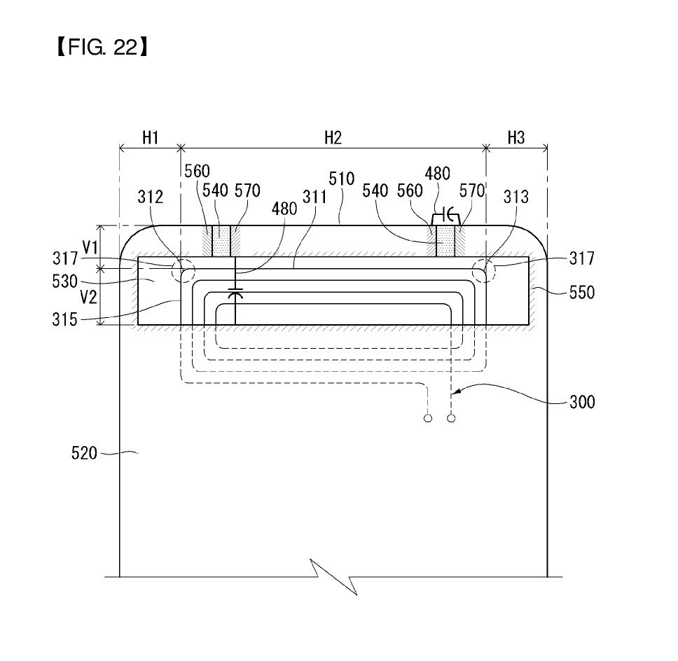

In FIGS. 20 to 22, two slits 540 are positioned at H2. That is, the slits 540 may be formed abut on a region between the start point 312 and the end point 313 of the first side 311. A connection relation of the connecting element 480 will be described below. As illustrated in FIG. 20, the connecting element 480 may connect the first slit adjacent portion 560 and the second slit adjacent portion 570. Also, as illustrated in FIG. 21, one connecting element 480 may connect the first slit adjacent portion 560 and the window adjacent portion 550 and the other connecting element 480 may connect the second slit adjacent portion 570 and the window adjacent portion 550. Also, as illustrated in FIG. 22, one connecting element 480 may connect the first slit adjacent portion 560 and the second slit adjacent portion 570, and the other connecting element 480 may connect the second slit adjacent portion 570 and the window adjacent portion 550. In this manner, a cover circuit in which a current is formed along the connecting element 480 and the conductive region 520 may be configured through the connection by the connecting element 480.

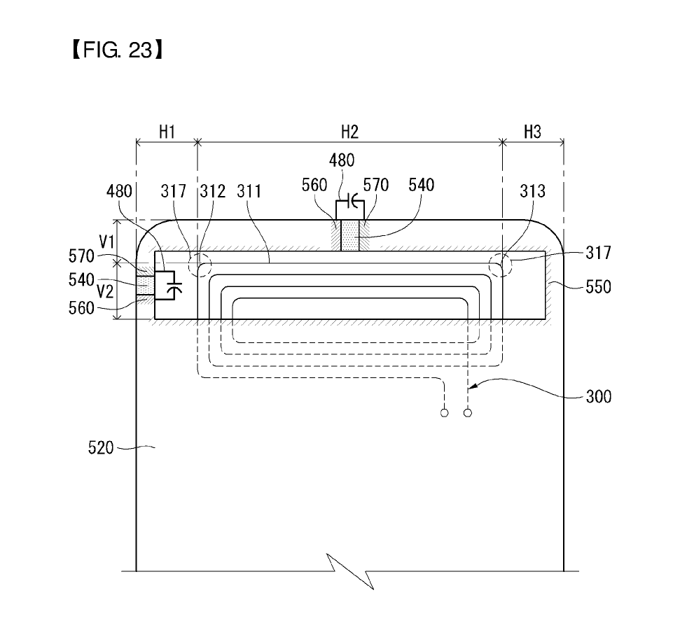

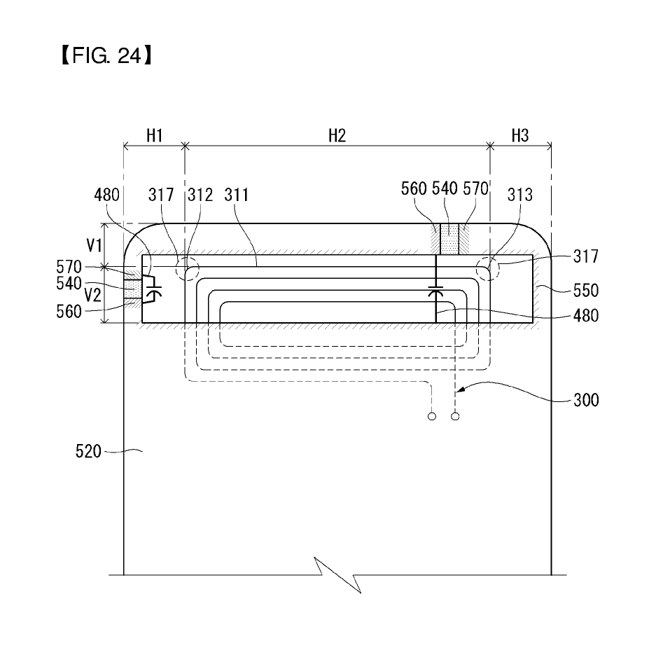

FIGS. 23 and 24 illustrate a position of the slit 540 and a connection relation of the connecting element 480.

In FIGS. 23 and 24, two slits 540 are positioned at H2 and V2, respectively. A connection relation of the connecting element 480 will be described. As illustrated in FIG. 23, one connecting element 480 may connect the first slit adjacent portion 560 and the second slit adjacent portion 570, and the other connecting element 480 may also connect the first slit adjacent portion 570 and the second slit adjacent portion 570. Also, as illustrated in FIG. 24, one connecting element 480 may connect the first slit adjacent portion 560 and the window adjacent portion 550 and the other connecting element 480 may connect the first slit adjacent portion 560 and the second slit adjacent portion 570. In this manner, a cover circuit in which a current is formed along the connecting element 480 and the conductive region 520 may be formed through the connection by the connecting element 480.

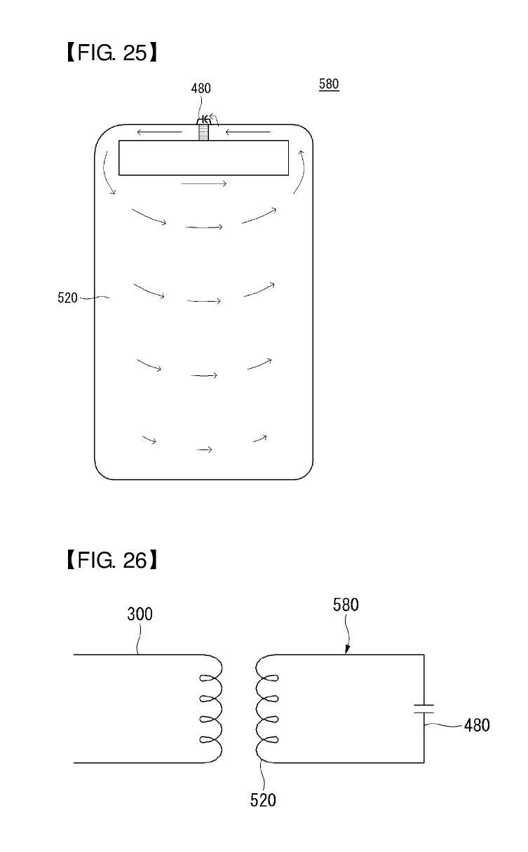

FIG. 25 illustrates an operation of the cover circuit according to an embodiment of the present invention. Since the cover circuit 580 may be inductively coupled with the short-range communication antenna, if a varying electric current is applied to the short-range communication antenna, a current may be induced in the cover circuit 580 inductively coupled with the short-range communication antenna. The arrows illustrated in FIG. 25 indicate the current induced in the cover circuit 580.

The cover circuit 580 may be formed on the cover along the conductive region 520 and the connecting element 480. A magnitude of the current induced in the cover circuit tends to increase toward the window region. This is because a magnitude of a varying electromagnetic force is affected by a distance to the short-range communication antenna overlapping the window region. In FIG. 25, the current formed in the cover circuit 580 may be formed in a counterclockwise or clockwise direction.

FIG. 26 illustrates an equivalent circuit for the short-range communication antenna 300 and the cover circuit 580 according to an embodiment of the present invention. The cover circuit 580 may include the conductive region 520 and the connecting element 480. A case where electromagnetic characteristics of the conductive region 520 are inductive may be considered. The electromagnetic characteristics of the connecting element 480 may be inductive or capacitive.

By regulating the electromagnetic characteristics of the connecting element 480, the short-range communication antenna 300 and the cover circuit 580 may resonate. Since the case where the electromagnetic characteristics of the connecting element 480 are inductive may be considered, the electromagnetic characteristics of the connecting element 480 may be specified to be capacitive for resonance of the cover circuit 580 and the short-range communication antenna 300. For example, when the frequency of the short-range communication antenna 300 is 13.56 MHz, an equation regarding resonance of the cover circuit 580 may be expressed as follows.

$$13.56 \times {10}^{6} = \frac{1}{2 π \sqrt{LC}}$$

In the above equation, ‘L’ denotes inductance of the cover circuit 580, and ‘C’ denotes capacitance of the cover circuit 580. Here, the conductive region 580 configuring the cover circuit 580 may be formed of a metal material and thus may have the properties of an inductor. Therefore, electromagnetic characteristics of the connecting element 480 may be capacitive for resonance of the cover circuit 580. In FIG. 26, the conductive region 580 having the properties of an inductor is indicated by an inductor symbol, and the connecting element 480 having the properties of a capacitor is indicated by a capacitor symbol. Drawings illustrating the connecting element 480 as the capacitor symbol are FIGS. 11 and 18 to 25, in addition to FIG. 26.

The electromagnetic characteristics of connecting element 480 may be fixed or variable. The impedance sensor 460 illustrated in FIG. 9 may sense impedance of the short-range communication antenna 300 and the controller (not shown) may change an electromagnetic characteristic value of the connecting element according to the equation regarding resonance.

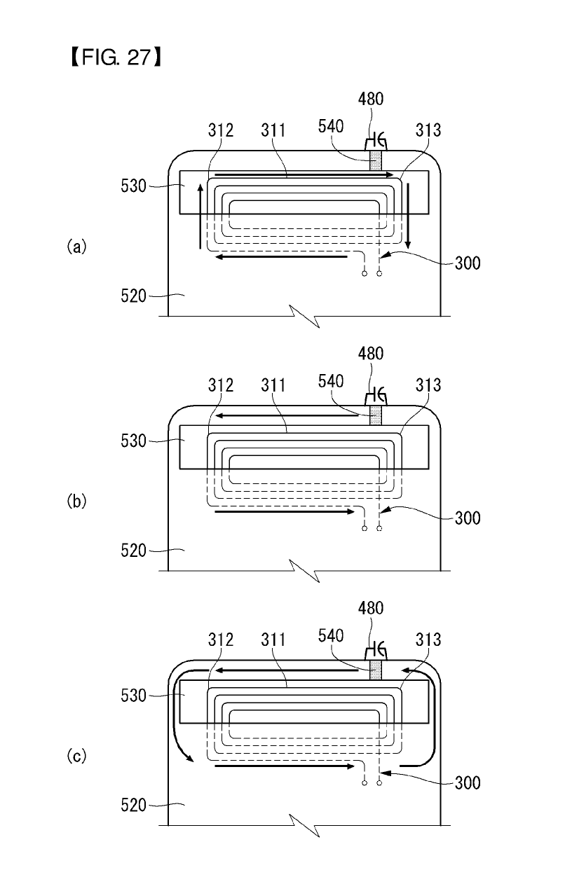

FIG. 27 illustrates driving of a short-range communication antenna and a cover circuit according to an embodiment of the present invention. In FIG. 27, a process in which a current is applied to the short-range communication antenna 300 and the cover circuit inductively coupled with the short-range communication antenna 300 propagates electromagnetic waves to the outside of the mobile terminal is illustrated. Although not illustrated in FIG. 27, a process in which a current is induced to the cover circuit as the cover circuit reacts to an electromagnetic wave outside the mobile terminal and a current is induced to the short-range communication antenna 300 inductively coupled with the cover circuit to receive information may be considered.

As illustrated in FIG. 27, a current may be driven in the short-range communication antenna 300. When a current is driven in the short-range communication antenna 300, the short-range communication antenna 300 propagates electromagnetic waves. The cover circuit reacts to the electromagnetic waves propagated from the short-range communication antenna 300, so that a current may be driven in the cover circuit. Here, if the electromagnetic characteristics of the connecting element 480 configuring the cover circuit are specified so that the cover circuit may resonate according to a frequency of the electromagnetic waves, a current may be driven in the cover circuit when energy loss is minimized.

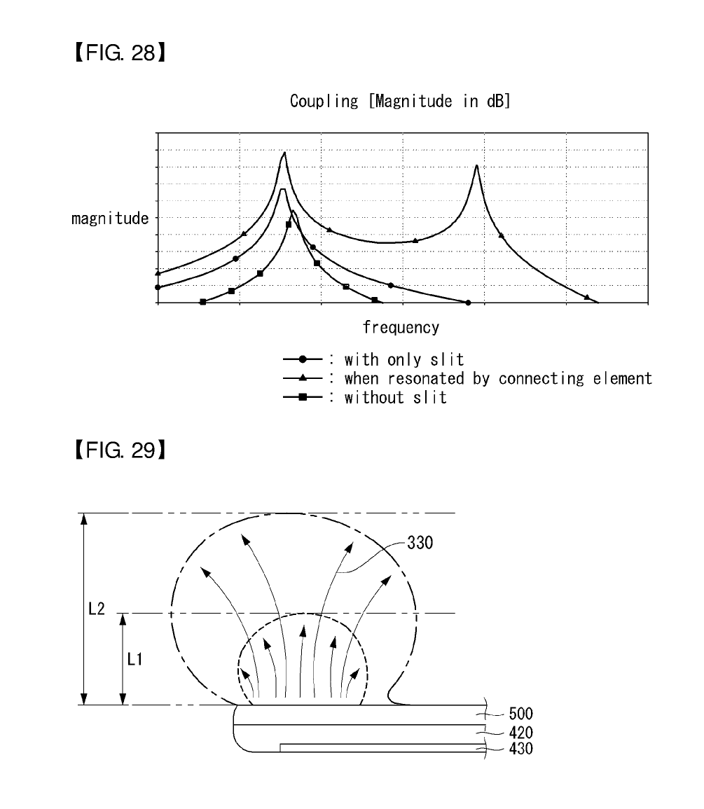

FIG. 28 illustrates an experimental example of a mobile terminal according to an embodiment of the present invention. FIG. 28 illustrates the results of experiment conducted when there is no slit, when there is only a slit, and when a cover circuit resonates using a connecting element.

In the absence of a slit, a closed loop may be formed on the cover with only the conductive region. In this case, however, it is difficult to form a resonance condition, and thus, the degree of inductive coupling with the short-range communication antenna is insignificant.

If there is only a slit, the slit may be formed across the conductive region, but a closed loop may be formed on the plane of the conductive region. Also, in this case, resonance conditions are difficult to form, the degree of inductive coupling with the short-range communication antenna is insignificant, as is the case without the slit.

Meanwhile, referring to the case where the cover circuit resonates using the connecting element, the degree of inductive coupling with the short-range communication antenna is higher than the above two cases. The degree of inductively coupling represents efficiency with regard to transfer of energy between the short-range communication antenna and the cover circuit. That is, as the degree of inductively coupling is higher, energy transfer efficiency between the short-range communication antenna and the cover circuit is increased. Therefore, as the degree of inductively coupling is higher, an effective tagging distance of the mobile terminal may be increased. As the effective tagging distance increases, it means that short-range communication using the mobile terminal is easy, and thus, when the cover circuit resonates using the connecting element, short distance communication using the mobile terminal may be facilitated.

Also, a plurality of peaked areas appear. The peak area with a highest degree of inductive coupling is based on resonance of the short-range communication antenna and the cover circuit. The peak region with a second highest degree of inductive coupling is based on resonance of the cover circuit itself. In this manner, the effect of preventing a degree to which the peak area based on the resonance of the short-range communication antenna and the cover circuit is inductively coupled at a frequency distant from a resonance frequency from being drastically lowered is obtained by the peak area based on the resonance of the cover circuit itself

FIG. 29 illustrates an example of a radiation effect of the short-range communication antenna according to an embodiment of the present invention. The dotted line represents a region where the electromagnetic wave 330 effectively reaches when the cover circuit is not formed, and the alternated long and short dash line represents a region where the electromagnetic wave 330 effectively reaches when a resonant cover circuit is formed. As described above, when the cover circuit resonates, the effective tagging distance may be increased. This means that the effective region of the electromagnetic wave 330 radiating from the cover circuit to the outside is expanded.

FIG. 29 illustrates an effective tagging distance L1 when the cover circuit does not resonate and an effective tagging distance L2 when the cover circuit resonates. FIG. 29 illustrates a case where the electromagnetic wave 330 is radiated on the cover 500, but it is the same as the case where the electromagnetic wave 330 is received from the outside of the mobile terminal.

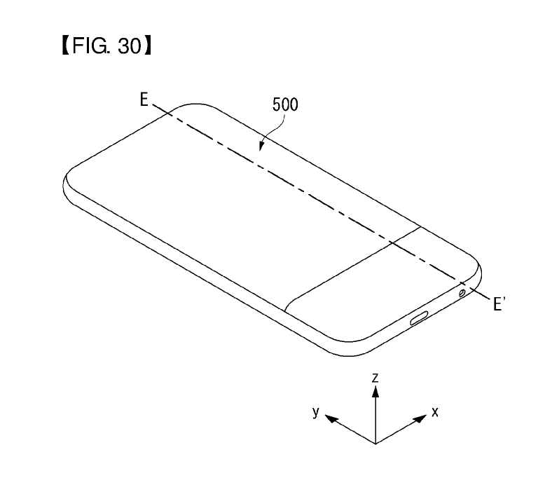

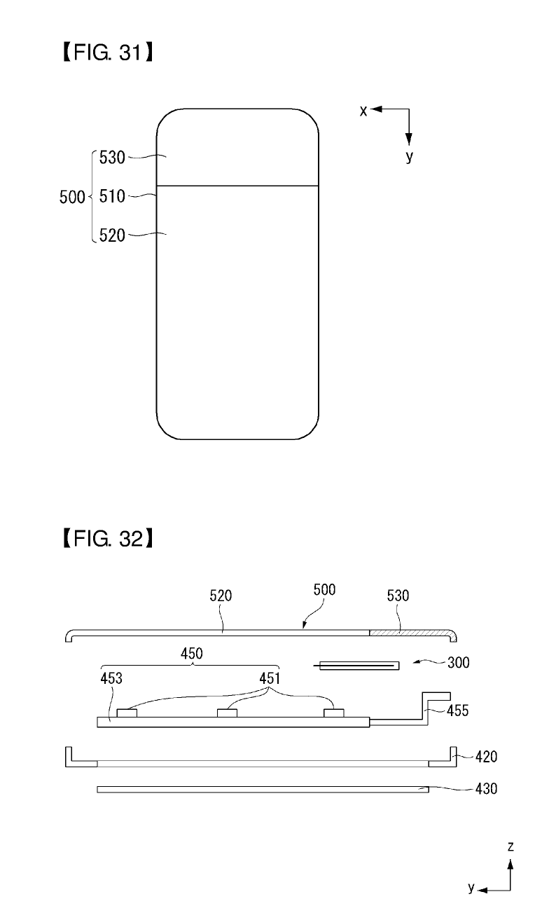

FIG. 30 is a view illustrating a mobile terminal according to another embodiment of the present invention, and FIG. 31 is a view illustrating a cover of the mobile terminal of FIG. 30. The cover 500 of the mobile terminal may include the conductive region 520 and the window region 530. The conductive region 520 and the window region 530 may be contiguous with each other.

The window region 530 may extend to the edge 510 of the cover 500 and a current does not flow in the window region 530 although a different potential is applied to a position spaced apart therefrom.

A current may flow in the conductive region 520 when a different potential is applied to a position spaced apart therefrom. The conductive region 520 may be formed of a metal material or may be formed by plastic injection and then coated with a metal material.

FIG. 32 is an exploded cross-sectional view of the mobile terminal of FIG. 30, taken along line E-E′. The mobile terminal may include the display panel 430, the short-range communication antenna 300, the frame 420, the PCB 450 and a rib 455. The cover 500 may be positioned on the rear surface of the display panel 430. The short-range communication antenna 300 may be positioned between the display panel 430 and the cover 500. The frame 420 may be a frame of the mobile terminal or a frame of the display panel 430. The frame 430 is for fixing an electronic component to an appropriate position.

The PCB 450 may be positioned between the display panel 430 and the cover 500 and may include a contact member 451 and a current path 453. The contact member 451 may be positioned on the current path 453 and may be abut on the conductive region 520. A current may flow in the current path 453. The PCB 450 is a printed circuit board, and a controller for controlling the mobile terminal may be mounted on the PCB 450.

The ribs 455 may be connected to the PCB 450. When different potentials are applied to both ends of the rib 455, a current may flow at both ends of the rib 455. Although not illustrated in the drawings, a case where both ends of the ribs 455 are connected to the conductive region 520 may also be considered.

The short-range communication antenna 300 may be positioned between the display panel 430 and the cover 500 or may be positioned between the cover 500 and the PCB 450. The short-range communication antenna 300 may overlap the window region 530 in at least a portion thereof. The short-range communication antenna 300 is insulated from the conductive region 520 so that no current may flow between the short-range communication antenna 300 and the window region 530.

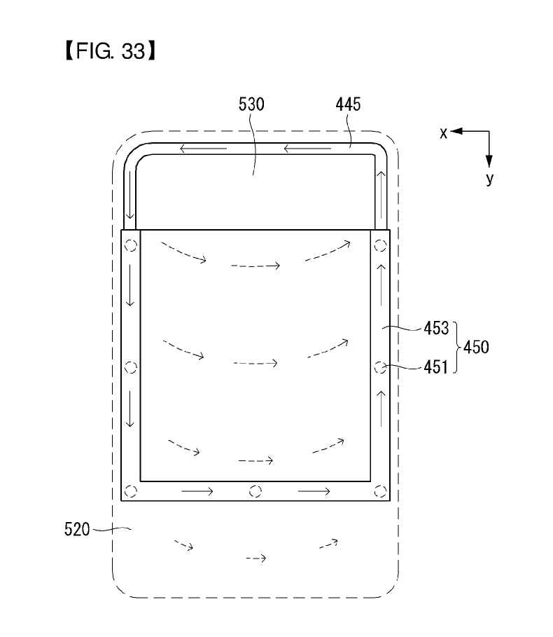

FIG. 33 is a view illustrating a cover circuit formed in the mobile terminal of FIG. 30. The PCB 450 may include the current path 453 through which current may flow. The contact member 451 may be positioned on the current path 453. The contact member 451 may be provided in plurality.

The rib 455 may be connected to both ends of the current path 453. A current may flow in the rib 455 and the current path 453 and the current path 453 and the conductive region 520 may be electrically connected through the contact member 451. Accordingly, a cover circuit may be formed along the conductive region 520, the current path 453, and the rib 455. The cover circuit may be inductively coupled with the short-range communication antenna 300.

Although not shown, the rib 455 may be directly connected to the conductive region 520. In this case, a cover circuit may be formed along the conductive region 520 and the rib 455.

In FIG. 33, the regions indicated by the dotted lines represent the conductive region 520 and the window region 530, respectively. Although not illustrated in FIG. 33, when an electromagnetic field (electromagnetic wave) is generated by the short-range communication antenna, a current may be induced in the cover circuit inductively coupled with the short-range communication antenna. The cover circuit and window region 530 may at least partially overlap.

The solid line arrows indicate an induced current flowing along the rib 455 and the current path 453, and the dotted arrows indicate an induced current flowing along the conductive region 520. By the current induced in the cover circuit by the short-range communication antenna 300, the mobile terminal may easily perform short-range communication, while using the cover 500 formed of a metal material. In other words, a current may be induced to the cover circuit by the short-range communication antenna 300, and an electromagnetic field (electromagnetic wave) may be formed (propagated) outside the mobile terminal by the current induced to the cover circuit.

The same is applied to the case of receiving an electromagnetic wave from outside the mobile terminal. A current is induced to the cover circuit by an electromagnetic field (electromagnetic wave) acting externally, and a current may be induced to the short-range communication antenna 300 by an electromagnetic field (electromagnetic wave) generated by the current induced to the cover circuit.

Since the cover circuit is inductively coupled with the short-range communication antenna 300, the cover circuit may resonate with the short-range communication antenna 300 when impedance of the cover circuit has a specific value. The rib 455 may include a connecting element having electromagnetic characteristics so that impedance of the cover circuit may have a specific value to resonate with the short-range communication antenna.

FIG. 34 is a block diagram illustrating a mobile terminal according to the present invention. FIG. 34 illustrates a wireless communication unit 110, an input unit 120, a sensing unit 140, an output unit 150, an interface unit 160, a memory 170, a controller 180, and a power supply unit 190.

The components illustrated in FIG. 34 are not essential for implementing a mobile terminal, and thus, the mobile terminal described herein may have more or fewer components than the components listed above.

In detail, among the components, the wireless communication unit 110 may include one or more modules which enable wireless communications between the mobile terminal 100 and a wireless communication system, between the mobile terminal 100 and another mobile terminal, or between the mobile terminal 100 and an external server. Also, the wireless communication unit 110 may include one or more modules connecting the mobile terminal 100 to one or more networks.

The wireless communication unit 110 may include at least one of a broadcast receiving module 111, a mobile communication module 112, a wireless Internet module 113, a short-range communication module 114, and a location information module 115.

The input unit 120 may include a camera 121 or an image input unit for inputting an image signal, a microphone 122 or an audio input unit for inputting an audio signal, a user input unit 123 (e.g., a touch key, a mechanical key, etc.) for receiving information from a user. Sound data or image data collected by the input unit 120 may be analyzed and processed by a user's control command.

The sensing unit 140 may include one or more sensors for sensing at least one of information in the mobile terminal, surrounding environment information of the mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., camera 121 and a microphone 122), a battery gauge, an environment sensor (for example, a barometer, a hygrometer, a thermometer, a radiation detection sensor, a thermal sensor, a gas sensor, etc.), and a chemical sensor (e.g., an electronic nose, a healthcare sensor, a biometric sensor, etc.). Meanwhile, the mobile terminal disclosed in the present disclosure may combine pieces of information sensed by at least two of the sensors to use the same.

The output unit 150 is for generating an output related to visual sense, auditory sense, a tactile sense, and the like, and includes at least one of a display unit 151, an audio output unit 152, a haptic module 153, and an optical output unit 154. The display unit 151 may have an inter-layered structure with the touch sensor or may be integrally formed with the touch sensor to realize a touch screen. The touch screen may serve as a user input unit 123 for providing an input interface between the mobile terminal 100 and a user and may provide an output interface between the mobile terminal 100 and the user.

The interface unit 160 serves as an interface with various kinds of external devices connected to the mobile terminal 100. The interface unit 160 may include a wired/wireless headset port, an external charger port, a wired/wireless data port, a memory card port, a port for connecting a device having an identification module, an audio input/output (I/O) port, a video I/O port, and an earphone port. In the mobile terminal 100, when an external device is connected to the interface unit 160, appropriate controlling related to the connected external device may be performed.

The memory 170 may store data supporting various functions of the mobile terminal 100. The memory 170 may store a plurality of application programs (or applications) driven in the mobile terminal 100 and data and commands for operation of the mobile terminal 100. At least some of these applications may be downloaded from an external server via wireless communication. Also, at least some of the application programs may be present in the mobile terminal 100 at the time when the mobile terminal is released for basic functions (e.g., a call receiving function, a call originating function, a message receiving function, or a message sending function) of the mobile terminal 100. Meanwhile, the application programs may be stored in the memory 170, installed on the mobile terminal 100, and driven by the controller 180 to perform an operation (or function) of the mobile terminal.

In addition to the operations related to the application program, the controller 180 typically controls a general operation of the mobile terminal 100. The controller 180 may provide or process appropriate information or function to the user by processing signals, data, information, and the like, input or output through the above-described components or driving an application program stored in the memory 170.

In addition, the controller 180 may control at least some of the components illustrated in FIG. 34 to drive the application program stored in the memory 170. In addition, the controller 180 may operate a combination of at least two of the components included in the mobile terminal 100 to drive the application program.

The power supply unit 190 receives external power and internal power under the control of the controller 180 and supplies power to the components included in the mobile terminal 100. The power supply unit 190 may include a battery, and the battery may be an internal battery or a replaceable battery.

At least some of the above-described components may operate in cooperation with each other to implement an operation, control, or a control method of the mobile terminal according to various embodiments described hereinafter. In addition, the operation, control, or control method of the mobile terminal may be implemented on the mobile terminal by driving at least one application program stored in the memory 170.

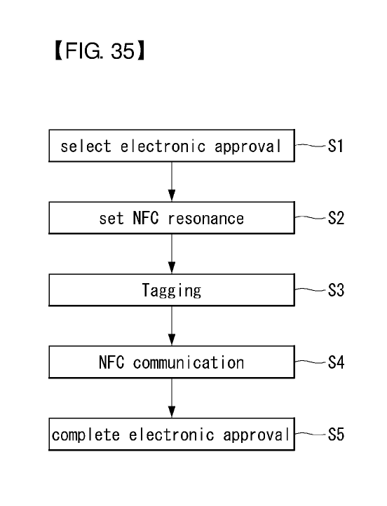

FIG. 35 illustrates an example of a short-range communication method of a mobile terminal according to an embodiment of the present invention. When an electronic approval function is selected in the mobile terminal (S1), an electromagnetic characteristic value of a connecting element is set so that a cover circuit may resonate with a short-range communication antenna in the mobile terminal (S2). The short-range communication antenna may be near field communication (NFC) antenna. When the mobile terminal is placed to be close to another local communication terminal within an effective tagging distance (S3), the short-range communication function is activated (S4), and accordingly, electronic approval may be performed (S5).

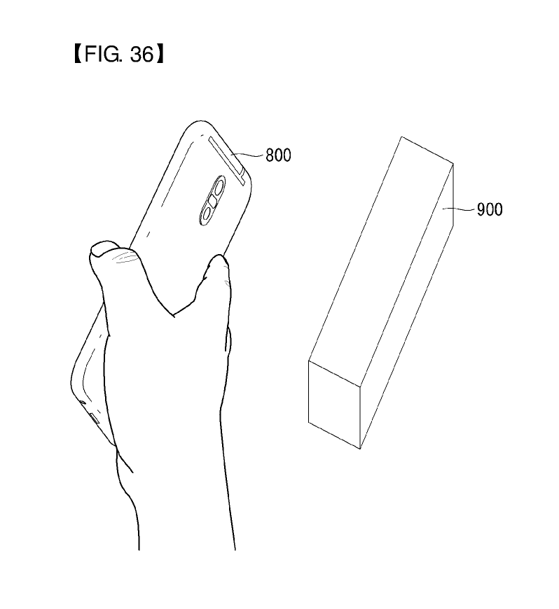

FIG. 36 illustrates an example of the use of a mobile terminal 800 according to an embodiment of the present invention. When the user uses the mobile terminal 800, the user generally grips the mobile terminal 800 with his or her hand as illustrated. With the mobile terminal 800 held in one hand, the user operates the mobile terminal 800 by touching a display of the mobile terminal 800 with the other hand. The user may conveniently perform electronic approval through the mobile terminal 800 according to the present invention, while maintaining the state of holding the mobile terminal 800. The user may conveniently and accurately perform electronic approval by tagging the mobile terminal 800 to another short-range communication terminal 900.

Hereinafter, embodiments related to a control method that may be implemented in the mobile terminal configured as above will be described with reference to the accompanying drawings. It will be apparent to those skilled in the art that the present invention may be embodied in other specific forms without departing from the spirit or essential characteristics thereof.

The present invention described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

1-20. (canceled)

21. A mobile terminal comprising:
a display panel;
a cover positioned at a rear side of the display panel, the cover having a window region and a conductive region surrounding the window region;
a short-range communication antenna positioned between the display panel and the cover, at least a portion of the short-range communication antenna overlapping the window region and insulated from the conductive region;
a connecting element positioned at one side of the cover, the connecting element having electromagnetic characteristics;
a slit formed on the cover, the slit extending from the window region to an edge of the cover across the conductive region; and
a cover circuit inductively coupled to the short-range communication antenna and which is formed on the cover along the connecting element and the conductive region.

22. The mobile terminal of claim 21, wherein at least a portion of the cover including the conductive region is formed of a metal material.

23. The mobile terminal of claim 21, wherein:
a window adjacent portion abutting the window region, a first slit adjacent portion, and a second slit adjacent portion are formed on the cover, each of the first slit adjacent portion and the second slit adjacent portion abutting the slit; and
the connecting element connects at least two regions among the first slit adjacent portion, the second slit adjacent portion, and the window adjacent portion.

24. The mobile terminal of claim 21, wherein the connecting element has an electromagnetic characteristic value at which the short-range communication antenna and the cover circuit resonate.

25. The mobile terminal of claim 21, wherein the window region is adjacent to the edge of the cover and elongated along the edge of the cover.

26. The mobile terminal of claim 25, wherein the slit extends from the window region to an edge adjacent to the window region or to an edge that the window region faces in a longitudinal direction.

27. The mobile terminal of claim 21, wherein a region in which at least a portion of the short-range communication antenna is bent is positioned inside a region overlapping the window region.

28. The mobile terminal of claim 21, wherein the short-range communication antenna has a quadrangular shape in at least a portion overlapping the window region.

29. The mobile terminal of claim 28, wherein:
at least one side of the short-range communication antenna overlaps the window region; and
at least one slit is formed abutting a region between a start point and an end point of the at least one side of the short-range communication antenna.

30. The mobile terminal of claim 28, wherein:
a first side of the short-range communication antenna overlaps the window region;
the slit is one of a plurality of slits;
a first slit among the plurality of slits is formed abutting a region between a start point and an end point of the first side; and
a second slit among the plurality of slits is formed abutting a second side of the short-range communication antenna extending from the first side.

31. The mobile terminal of claim 30, wherein:
at least one region of the second side overlaps the window region; and
at least another region of the second side overlaps the conductive region.

32. The mobile terminal of claim 28, wherein:
at least one side of the short-range communication antenna overlaps the window region; and
the slit is formed abutting a region excluding a region between a start point and an end point of the at least one side.

33. A mobile terminal comprising:
a display panel;
a cover positioned at a rear side of the display panel, the cover having a window and a conductive region surrounding the window;
a short-range communication antenna positioned between the display panel and the cover, at least a portion of the short-range communication antenna overlapping the window and insulated from the conductive region;
a connecting element positioned at one side of the cover, the connecting element having electromagnetic characteristics; and
a slit formed on the cover, the slit extending from the window region to an edge of the cover across the conductive region,
wherein at least a portion of a second region including the window in a direction from the display panel toward the cover is positioned inside a first region including the short-range communication antenna.

34. The mobile terminal of claim 33, wherein a third region including the slit is positioned outside the first region.

35. The mobile terminal of claim 33, wherein:
a window adjacent portion abutting the window, a first slit adjacent portion, and a second slit adjacent portion are formed on the cover, each of the first slit adjacent portion and the second slit adjacent portion abutting the slit; and
the connecting element connects at least two regions among the first slit adjacent portion, the second slit adjacent portion, and the window adjacent portion.

36. The mobile terminal of claim 33, further comprising:
a cover circuit inductively coupled to the short-range communication antenna and which is formed on the cover along the connecting element and the conductive region,
wherein the connecting element has an electromagnetic characteristic value at which the short-range communication antenna and the cover circuit resonate.

37. A mobile terminal comprising:
a display panel;
a cover positioned at a rear side of the display panel, wherein a least a portion of the cover is formed of a metal material;
a short-range communication antenna positioned between the display panel and the cover; and
a resonating unit disposed at one side of the cover to form a closed loop together with a conductive region of the cover formed of a metal material, the resonating unit providing electromagnetic characteristics such that the closed loop is inductively coupled with the short-range communication antenna and resonates.

38. The mobile terminal of claim 37, wherein:
the cover has a window surrounded by the metal material of the cover, the cover including a slit extending from the window to an edge of the cover across the conductive region on the cover;
a window adjacent portion abutting the window, a first slit adjacent portion, and a second slit adjacent portion are formed on the cover, each of the first slit adjacent portion and the second slit adjacent portion abutting the slit; and
the cover further includes a connecting element connecting at least two regions among the first slit adjacent portion, the second slit adjacent portion, and the window adjacent portion.

39. A mobile terminal comprising:
a display panel;
a cover positioned at a rear side of the display panel, the cover having a conductive region and a window region, wherein the window region is adjacent to the conductive region and extends to an edge of the cover;
a short-range communication antenna positioned between the display panel and the cover, at least a portion of the short-range communication antenna overlapping the window region and insulated from the conductive region;
a printed circuit board (PCB) positioned between the display panel and the cover, the PCB having a contact member abutting the conductive region and providing a current path through which current flows;
a rib connected to opposing ends of the current path such that the current flows through the rib; and
a cover circuit inductively coupled with the short-range communication antenna and which is formed along the conductive region, the current path, and the rib.

40. The mobile terminal of claim 39, wherein the cover circuit and the window region overlap at least partially in a direction from the display panel toward the cover.
